(19) United States
(12) Patent Application Publication
(10) Pub. No.: US 2007/0284945 A1
(43) Pub. Date: Dec. 13, 2007

(54) Map pocket illumination

(76) Inventor: David A. Hein, Sterling Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(21) Appl. No.: 11/451,701

(22) Filed: Jun. 13, 2006

(51) Int. Cl. B60L 1/14

(52) U.S. Cl. 307/10.8

(57) ABSTRACT

A map pocket or other compartment illumination system. The system suitable for use in any number of environment and application where it is desirable to illuminate a storage location in response to definable illumination events.

### BACKGROUND OF THE INVENTION

1. Field of the Invention

The present invention relates to illumination of map pockets and other openings and compartments within vehicle doors and other storage areas.

2. Background Art

Vehicle doors include any number of openings and storage areas, commonly referred to as map pockets. The map pockets hold objects during transport and are typically positioned within arms reach of passengers so that passengers can reach into the map pockets to insert and retrieve the objects.

The map pockets may be located and orientated in poorly illuminated areas such that the contents are difficult to discern. This can be problematic when trying to locate and retrieve the objects and/or to position newly inserted objects.

### SUMMARY OF THE INVENTION

One non-limiting aspect of the present invention relates to over-coming the above-identified problem with a illuminable map pocket.

One non-limiting aspect of the present invention relates to providing an illumination source proximate the map pocket. The illumination source may be controlled to illuminate a portion of the map pocket.

One non-limiting aspect of the present invention relates to a controller configured for automatically controlling the illumination source.

One non-limiting aspect of the present invention relates to a sensor positioned within and/or proximate to the map pocket and to controlling illumination of the illumination source as function of the sensor sensing activity with respect to the same.

One non-limiting aspect of the present invention relates to the controller determining whether an object is being inserted within or removed from the map pocket and controlling map pocket illumination as a function thereof.

One non-limiting aspect of the present invention relates to the controller determining whether an object within the map pocket is undergoing assisted or unassisted movement and controlling map pocket illumination as a function thereof.

One non-limiting aspect of the present invention relates to the controller discriminating an object entering the storage area versus moving outside of the map pocket, and only enabling illumination when the object enters the storage area.

One non-limiting aspect of the present invention relates to a system for illuminating a map pocket of a vehicle door. The system may include a sensor located within the map pocket and configured to generate signals as a function of objects in proximity thereto, an illumination source for illuminating at least a portion of the map pocket, and a controller in communication with the sensor and illumination source and configured to controllable illuminate the illumination source as a function of the signals generated with the sensor array.

One non-limiting aspect of the present invention relates to a method of controlling an illumination source within a map pocket of a vehicle door. The method may include determining an illumination event and illuminating the illumination source in response to determining the illumination event.

One non-limiting aspect of the present invention relates to a compartment within a vehicle for storing items. The compartment may included a sensor in proximity to the compartment and configured to generate signals as a function of objects in proximity thereto, and an illumination source in proximity to the compartment and configured to illuminate the compartment as a function the sensor signals.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a map pocket illumination system in accordance with one non-limiting aspect of the present invention;

FIG. 2 illustrates a more detailed schematic view of the sensors in accordance with one non-limiting aspect of the present invention;

FIG. 3 illustrates a cross-sectional view of the map pocket in accordance with one non-limiting aspect of the present invention; and

FIG. 4 illustrates a flowchart of a method of controllably illuminating the map pocket in accordance with one non-limiting aspect of the present invention

### DETAILED DESCRIPTION OF THE PREFERRED EMBODIMENT(S)

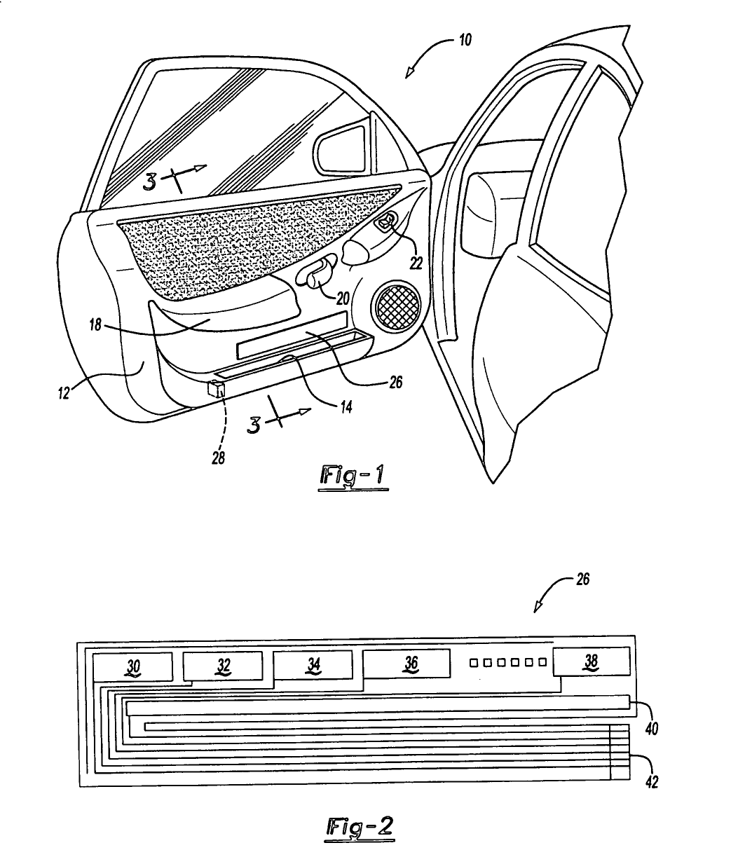

FIG. 1 illustrates a map pocket illumination system 10 in accordance with one non-limiting aspect of the present invention. The system 10 is generally illustrated with respect to a vehicle door 12 having one or more compartments, commonly referred to as a map pocket 14. The vehicle door 12 may include any number of other features and elements, including an armrest 18, door handle 20, and electronic actuation buttons 22, such those use for locking doors and adjusting windows.

A sensor 26 and an illumination source 28 may be included to facilitate illuminating the map pocket 14. The illumination source may be any element suitable for illuminating a portion of the map pocket 14, including LEDs, incandescent bulbs, electroluminescent elements, and the like. Optionally, more than one illumination source 28 may be included to illuminate different portions of the map pocket.

A controller (not shown) may be included or otherwise in communication with the sensor 26 and the illumination source 28. The controller may be configured to automatically or otherwise control illumination of the illumination source 28 as a function of signals received from the sensor 26. The controller may include memories, processors, and other elements required to execute the operations of the present invention.

In this manner, the present invention is able to selectively control illumination of the map pocket 14, such as to facilitate illuminating ingress and egress of objects to and from the map pocket 14. The vehicle door 12 and other features are shown for exemplary purposes and without intending to limit the scope and contemplation of the present invention.

The present invention contemplates its application in any number of environments where it may be desirable to controllably illuminate compartments, storage areas, bins, and the like as a function of movements detected with the sensor 26. The present invention is not intended to be limited to the foregoing.

FIG. 2 illustrates a more detailed schematic view of the sensor 26 in accordance with one non-limiting aspect of the present invention. The sensor 26 may be arranged into an array such that the sensor includes a number of sensor cells 30-40 in the array. The illustrated array includes a number of sensors 30-38 in a top row and a single larger sensor 40 in a bottom row.

The sensors 30-40 may be capacitive, infrared, inductive, or any other type of sensor having sufficient capabilities to generate signals as a function of objects in proximity thereto. The signals generated by the sensors 30-40 may be communicated to the controller over a Flexible Printed Circuit (FPC) wiring jumper or other communication medium 42.

The signals generated by the sensors 30-40 may be processed by the controller for use in analyzing movement of objects with respect to the map pocket 14. In this manner, the present invention is able to determine whether an object is entering, exiting, or moving within the map pockets. The controller may then use this and/or other information for selectively controlling illumination of the map pocket 14 or other areas associated with the map pocket 14 or surrounding environment.

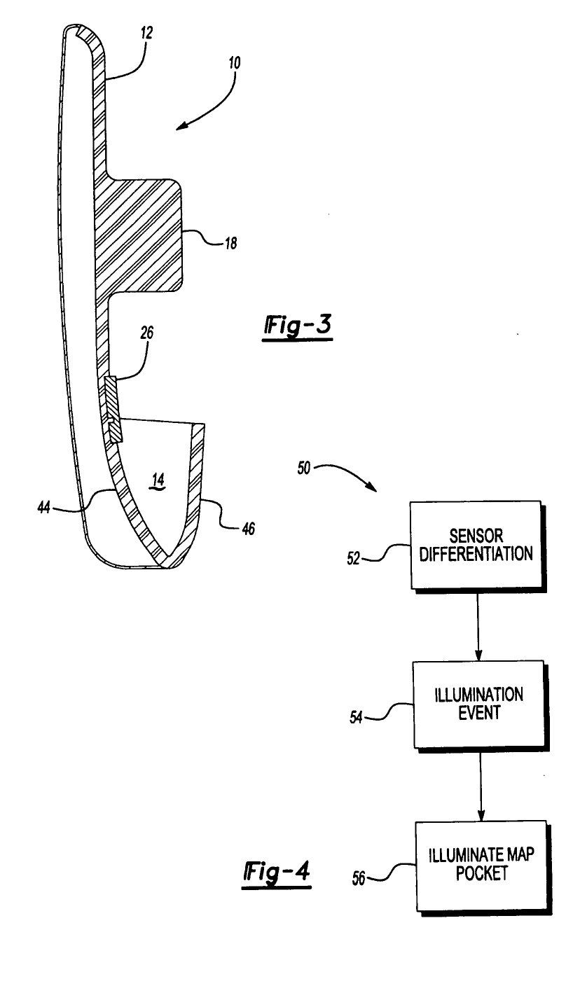

FIG. 3 illustrates a cross-sectional view of the map pocket 14 in accordance with one non-limiting aspect of the present invention. The map pocket 14 is generally positioned below a portion of the armrest 18 and includes a storage area defined by outboard and inboard walls 44-46. The sensors 30-40 may be positioned within or on either wall 44-46 to detect objects in proximity to the boundaries of the map pocket 14, including objects inside and outside of the walls 44-46.

The sensors 30-40 may be positioned relative to a top side of the map pocket 14 so as to focus sensing to a top portion of the map pocket 14. This enables the detection of objects entering or exiting the map pocket 14 and helps to ignore objects that may be rolling around in the bottom of the storage compartment 14. It also helps to ignore objects that are currently in the storage bin 14 and detecting new objects and limits the number of sensors 30-40 needed to detect movement with respect to the map pocket.

Of course, the present invention fully contemplates the sensors 30-40 may be positioned along any portion of the vehicle door 12 and in any number of other arrangements besides the illustrated columns and rows. Accordingly, the present invention is not intended to be limited to the foregoing and fully contemplates the sensors being positioned anywhere proximate to the map pocket and not necessarily proximate to the top side.

The sensors 30-40 may continuously or intermittently generate signals as a function of objects in proximity thereto. The travel of an object may be determined as a function of cell differentiation associated with individually assessing the signals generated by each cell 30-40 influenced by the object's path of travel. As the object travels past the boundaries of each cell 30-40, the cells 30-40, over time, generate signals that vary according to the position and travel of the object with respect thereto. The controller may be configured to differentiate these signals and to determine movement of the object as a function thereof.

This information and information from previous object movements, which may be stored by the controller, may be used to reach conclusions with respect to the object and its movement relative to the map pocket 14. Information associated with multiple objects may be tracked and monitored by the controller so as to facilitate illumination with respect to new objects entering the map pocket 14 and old objects exiting and/or moving within the map pocket 14.

The objects sensed by the sensors 30-40 may include properties that influence operations of the sensors 30-40. For example, if the sensors 30-40 are capacitive based sensors, the size, composition, proximity, and other parameters of the object(s) may influence the accuracy or sensing distance of the sensors 30-40. Therefore, the controller may be configured to adjust sensor sensitivity and/or to otherwise compensate for such variability when analyzing the sensor signals so that accurate determinations can be made with respect to the object and location of the object within the bin 14 or outside the bin 14.

FIG. 4 illustrates a flowchart 50 of a method of controllably illuminating a map pocket or other entity in accordance with one non-limiting aspect of the present invention. The method and operations associated therewith may be embodied in computer-readable instructions or other types of logic suitable for operation with the controller and/or illumination source to control the illumination of the same.

Block 52 relates to differentiating the signals generated by the one or more sensors. The sensor differentiation allows a controller to determine movement of objects relative to the map pocket as a function of sensor variations. With respect to the exemplary sensor configuration shown in FIG. 3, the top row of sensors may be used to sense lateral motion of an object as a function of it traveling across the boundaries of the individual cells of the top row. The larger, unitary sensor cell in the bottom row may be used to sense vertical motion of the object as a function of it traveling across boundaries of the cells of the top and bottom row.

The signal differentiation and layout of the sensor array may be configured to facilitate determining any number of movements of the object, which may generally include assisted and unassisted movement. The assisted movement may be characterized as object movement induced by a vehicle passenger or some other intended movement, such as but not limited to the passenger using their hand to insert or remove the object from the map pocket. The unassisted movement may be characterized as object movement not induced by the vehicle passenger, such as but not limited to movement caused by the object falling within the map pocket on its own or in response to movement caused by vehicle operations (bumps, stops, vibration, etc.).

In this manner, the present invention may be able to determine fore/aft, side-to-side, and any number of other movements of the object or multiple objects within the map pocket. This information may be kept by the controller or other entity so that subsequent movements can be monitored and compared to previous movements. This may be helpful in determining whether the object movement is assisted or unassisted.

Block 54 relates to determining an illumination event. The illumination events generally correspond with any definable movement of the object in response to which the illumination source is illuminated. Optionally, the illumination event may correspond with any assisted movement of the object such that the map pocket is illuminated for assisted movement and not unassisted movement.

The assisted movement may include the passenger inserting a new object into the map pocket, removing an existing object from the map pocket, re-positioning an existing object with the map pocket, and other movements where the sensors detect an new object (hand, device, etc.) being inserted with the map pocket, either to be placed within the map pocket or to move another object already in the map pocket. In contrast, the unassisted movement generally corresponds with movement of objects already within the map pocket without entry of another. object (hand, device, etc.) to actuate such movement.

The determination of an illumination event may include compensating for sensor sensitivity changes. As objects are stored within the map pocket, moved within proximity thereto (either inside or outside of the map pocket), or otherwise positioned within a zone of influence to the sensors, the signals outputted by the sensors may vary such that objects not in proximity to the map pocket are sensed due to changes in sensor sensitivity. As such, changes in sensor sensitivity may be compensated for so as to prevent determining illumination events as a function of non-relevant movements beyond those associated within inserting, removing, or re-positioning of objects within the map pocket.

Block 56 relates to illuminating the map pocket in response to determining the illumination event. The illumination may correspond with the controller controlling illumination of the illumination source. The illumination source may be controlled to emit light for a predefined interval of time, flash, or otherwise illuminate according to another methodology. Optionally, the illumination may be controlled to correspond with the movement of the object within the map pocket such that different portions of the map pocket are illuminated depending on the positioning of the object. Likewise, the period of illumination may corresponding with a period of movement of the object or some other period that varies as a function of object movement.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for illuminating a map pocket of a vehicle door, the system comprising:
a sensor located within the map pocket and configured to generate signals as a function of objects in proximity thereto;
an illumination source for illuminating at least a portion of the map pocket; and
a controller in communication with the sensor and illumination source and configured to controllable illuminate the illumination source as a function of the signals generated with the sensor array.

2. The system of claim 1 wherein the sensor includes an array of sensing cells, each cell generating signals as a function of objects in proximity thereto such that the controller controllably illuminates the illumination source as a function of the signals associated with each cell.

3. The system of claim 2 wherein the controller is configured to illuminate the illumination source as a function of differential sensing provided by each cell indicating the object to be entering the map pocket or being removed therefrom and.

4. The system of claim 1 wherein the controller is configured to determine whether the object is entering or exiting the map pocket such that illumination of illumination source is limited to when the object is entering or exiting the map pocket.

5. The system of claim 1 wherein the controller is configured to determine whether the object is moving unassisted within the map pocket and to prevent illumination if the object is unassisted.

6. The system of claim 1 wherein the controller is configured to determine whether the object is moving with assistance within the map pocket and to illuminate the illumination source if the object is assisted.

7. The system of claim 1 wherein the controller is configured to determine whether to object is within the map pocket or outside the map pocket and to illuminate the illumination source if the object is within the map pocket and to prevent illumination if the object is outside of the map pocket.

8. The system of claim 1 wherein the controller is configured to adjust for a sensor sensitivity change as a function of the objects within the map pocket.

9. The system of claim 1 wherein the controller is configured to illuminate the illumination source for a predefined period of time upon determining the object to be entering the map pocket or moving with assistance.

10. A method of controlling an illumination source within a map pocket of a vehicle door, the method comprising:
determining an illumination event; and
illuminating the illumination source in response to determining the illumination event.

11. The method of claim 10 further comprising determining the illumination event as a function of two or more sensors positioned relative to the map pocket and configured to detect movement in close proximity thereto.

12. The method of claim 11 further comprising determining the illumination event as a function of sensor differentiation associated with comparing individual sensor signals against each other.

13. The method of claim 12 further comprising determining the illumination event as function of sensor differentiation indicating assisted or unassisted movement of an object relative to the map pocket.

14. The method of claim 11 further comprising compensating for sensor sensitivity changes due to an object in proximity to the map pocket and determining subsequent illumination events as a function of the compensated sensor sensitivity.

15. The method of claim 14 further comprising only compensating for sensors associated with a zone of influence defined relative to the object within the map pocket

16. The method of claim 10 associating the illumination event with entering, exiting, or assisted moving of an object relative to the map pocket.

17. A compartment within a vehicle for storing items comprising:
a sensor in proximity to the compartment and configured to generate signals as a function of objects in proximity thereto;
an illumination source in proximity to the compartment and configured to illuminate the compartment as a function the sensor signals.

18. The compartment of claim 17 wherein the sensor includes a number of individual sensor cells, each sensor cell generating different signals as a function of the object moving differently with respect to each cell such that the illumination source is configured to illuminate the compartment by differentiating the signals associated with each cell.

19. The compartment of claim 18 wherein the sensor includes a top row of individual sensor cells and a bottom row of a single continuous sensor cell.

20. The compartment of claim 19 wherein the sensor is positioned proximate to a top side of the compartment.
